(19) United States
(12) Patent Application Publication
(10) Pub. No.: US 2003/0184114 A1
(43) Pub. Date: Oct. 2, 2003

(54) Structure and manufacturing device for a sealing strap of windshield with variable section

(75) Inventor: Yung-Ching Huang, Tao Yuan Hsien (TW)

Correspondence Address: BRUCE H. TROXELL, SUITE 1404, 5205 LEESBURG PIKE, FALLS CHURCH, VA, 22041, US

(73) Assignee: YIH-TAIR INDUSTRIAL CO., LTD.

(21) Appl. No.: 10/107,140

(22) Filed: Mar. 28, 2002

(51) Int. Cl. B60J 10/02

(52) U.S. Cl. 296/96.21

(57) ABSTRACT

The present invention relates to a structure and manufacturing device for a sealing strap of windshield with variable section, more specifically, to a structure and manufacturing device used as a connecting device to connect a windshield frame and a windshield, also to a structure and manufacturing device which can be manufactured by modeling technology. Said invention comprises a main body, on the end thereof with a windshield frame connecting part which enable the present invention to be fixed on said windshield frame. On the front end of said main body, a containing slot for windshield is placed and with detachable dual-side tape and non-dry glue being placed within said containing slot. Beside said containing slot of said main body on two sides of said windshield, water blocking blades are placed, and in the inside bottom thereof, there is drain slot being placed to drain out huge volume of water generated suddenly in heavy rains or a storm in which a driver driving a car. The modeling technology adapted in manufacturing said present invention overcomes the disadvantage of higher cost caused by many processes applying on a similar product and the weakness of sealing problem in prior art.

### BACKGROUND OF THE INVENTION

(1). Field of the Invention

The present invention relates to a structure and manufacturing device for a sealing strap of windshield with water blocking blade and variable section, more specifically, to a structure and manufacturing device being used as a connecting device to connect a windshield frame and a windshield, also to a structure and manufacturing device which can be manufactured by modeling technology.

(2). Description of the Prior Arts

A windshield is a basic and indispensable component of a car, which provides the function of protection for the driver and the passengers in the car. Please refer to FIG. 1. Conventionally, in prior art, the windshield A is made of fragile glass, however, the material being used to make the windshield frame B is metal. Therefore, in order to combine the windshield glass A and the windshield frame B seamlessly and to prevent the windshield glass A from break, usually, the sealing strap C working as a cushion and being placed in between is made of rubber or plastic material. In prior art, said sealing strap C only fulfills simple function to wrap around and fix said windshield glass A. When driving a car in the rain, with car wiper D swinging and wiping out the rain drops on the windshield A, much rain water will be wiped out away toward the two sides E of said windshield A and further splash toward the side windows of the car, especially toward the side window beside the driver, which is negatively impacts the driver's vision toward the rear-view mirror. To solve the said problem, some car manufacturers had placed a water blocking blade F (as shown in FIG. 2) on said sealing strap C on both sides of said windshield A to prevent the rain flowing toward on said driver side window.

However, the aforesaid improvements still have the disadvantages as follows:

(1) Since said water blocking blade F only being placed on the right and left side of said sealing strap G of said windshield A, the whole sealing strap G has to be made into four sections first; the upper, lower, right and left one, and four connectors H will be used to connect said four sections to make a whole sealing strap G. More, for the shape of said upper and lower portion is different with that of said right and left one, four different independent manufacturing processes thereof are necessary. Doing so only increase the complexity of manufacturing and inventory, and further increase the production cost therefore.

(2) Since the whole sealing strap G has to be made into four sections first and assembled into a whole one with said connector H, the production processes are complex and tedious, also, the connection between each other will not be as good enough as that in modeling technology. Sealing problem always happened.

(3) The containing volume of rainwater is limited. For said volume is limited, the rain will still flow over toward the side window beside the driver when driving in a big rain or a storm.

### SUMMARY OF THE INVENTION

The primary object of the present invention is to provide a structure for a sealing strap of windshield having water blocking blade that its section is variable, more specifically, it is a structure used as a connecting device to connect a windshield frame and a windshield, also a structure which can be manufactured by modeling technology. Said invention comprises a main body, on the end thereof with a windshield frame connecting part which enabling the present invention to be fixed on said windshield frame. On the front end of said main body, a containing slot for windshield is placed, and within said containing slot, detachable dual-side tape or non-dry glue is placed. Beside said containing slot of said main body on two sides of said windshield, water blocking blades are placed, and in the inside bottom thereof, there is drain slot being placed to drain out huge volume of water generated suddenly in heavy rains or a storm in which a driver driving a car. The modeling technology adapted in production of said present invention overcomes the disadvantage of higher cost caused by multiple processes applying on a similar product and solves the problem of sealing in prior art.

The second object of the present invention is to provide a structure for a sealing strap of windshield having water blocking blade that its section is variable, wherein, said main body and said windshield frame connecting part are made of at least two different material respectively with different hardness by modeling technology to obtain best joint performance.

The third object of the present invention is to provide a structure for a sealing strap of windshield having water blocking blade that its section is variable, wherein, said water blocking blade is with drain slot placed within to drain out huge volume of water generated suddenly in heavy rains or a storm in which a driver driving a car.

The forth object of the present invention is to provide a manufacturing device to produce a sealing strap of windshield having water blocking blade that its section is variable, wherein, said device comprises extruder, mold, cooling tank, take up unit, cutter and controller. Said extruder will extrude raw material to said mold to build up the shape of the product. Said product will be further sent into cooling tank and then said take up unit will apply proper guiding force on said product to control the size of product, then finally, said cutter will cut said product to complete the entire process. Wherein, said mold comprises a main mold body and at least two sets of sliding blocks that can move back and forth, and the movement of said sliding block is controlled by said controller.

The appended drawings will provide further illustration of the present invention, together with the description, serve to explain the principles of the invention.

### BRIEF DESCRIPTION OF THE DRAWINGS

FIG. 1 shows a outlook diagram of a sealing strap for windshield in prior art.

FIG. 2 shows a outlook of another sealing strap for windshield in prior art.

FIG. 3 shows a 3D diagram of a embodiment of the present invention.

FIG. 4A shows a sectional view of one embodiment of the present invention relative to the upper and lower side of windshield.

FIG. 4B shows a sectional view of one embodiment of the present invention relative to the right and left side of windshield.

FIG. 4C shows a sectional view of another embodiment of the present invention relative to the upper and lower side of windshield.

FIG. 4D shows a sectional view of another embodiment of the present invention relative to the right and left side of windshield.

FIG. 5 shows a top view of the manufacturing device of the present invention.

FIGS. 6A and 6B show the top view of the operation of the mold of the manufacturing device of the present invention.

FIG. 7 shows a sectional 3D diagram of the present invention.

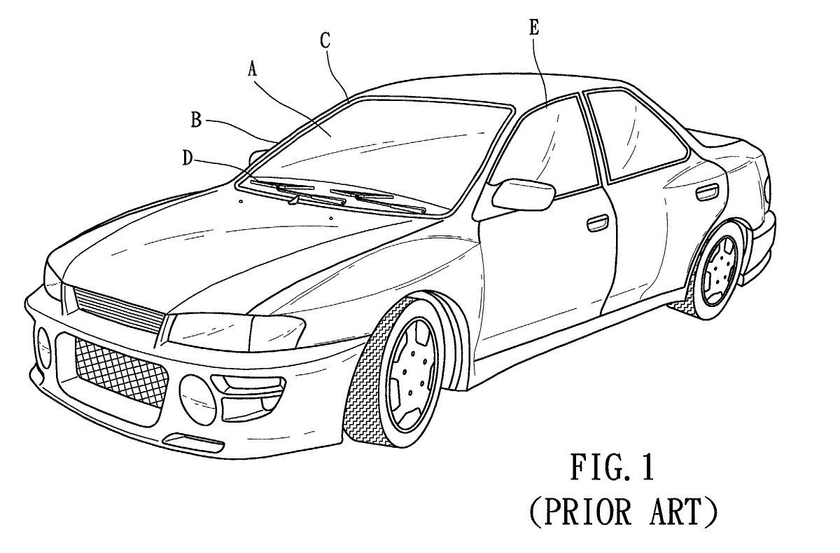

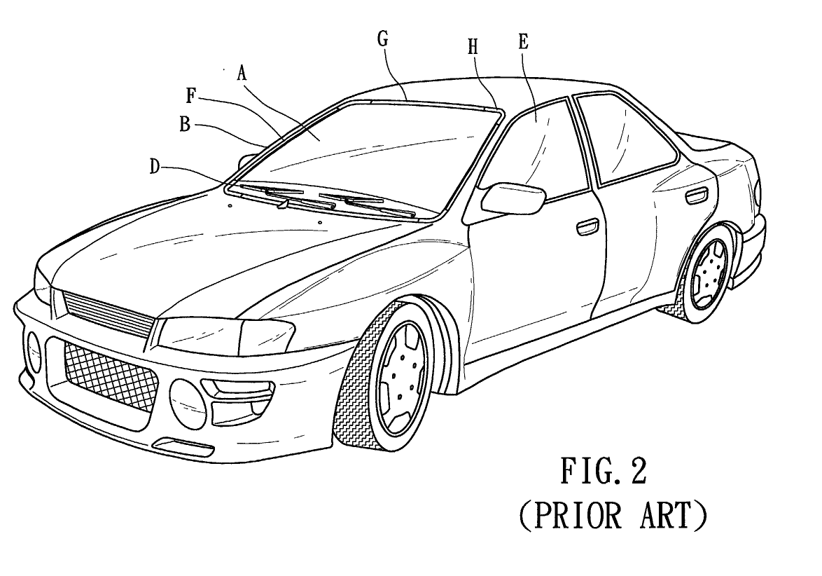

### DETAILED DESCRIPTION OF THE PRESENT INVENTION

The following embodiments will illustrate detail information of the operation, the method and the performance of the sealing strap structure of the windshield of the present invention.

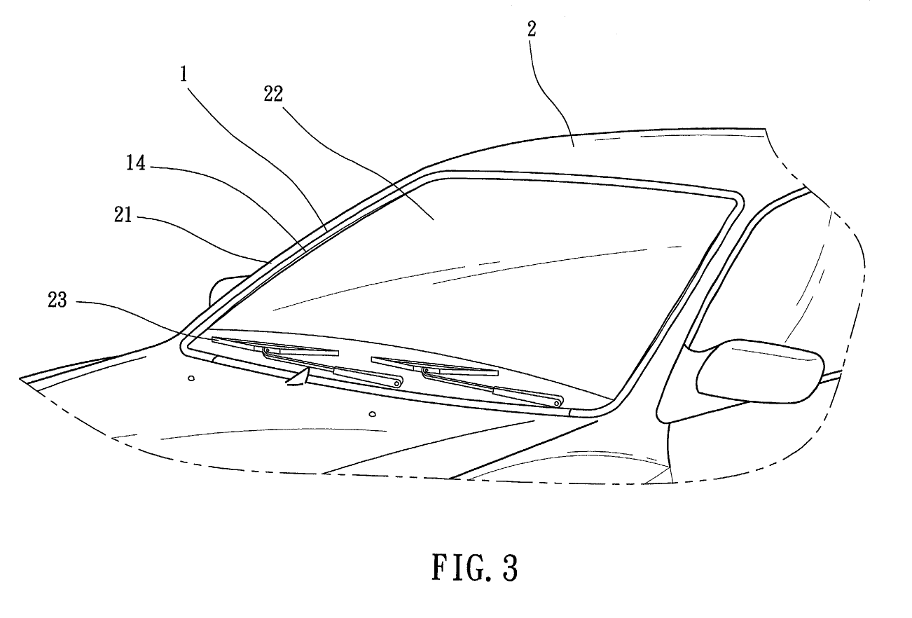

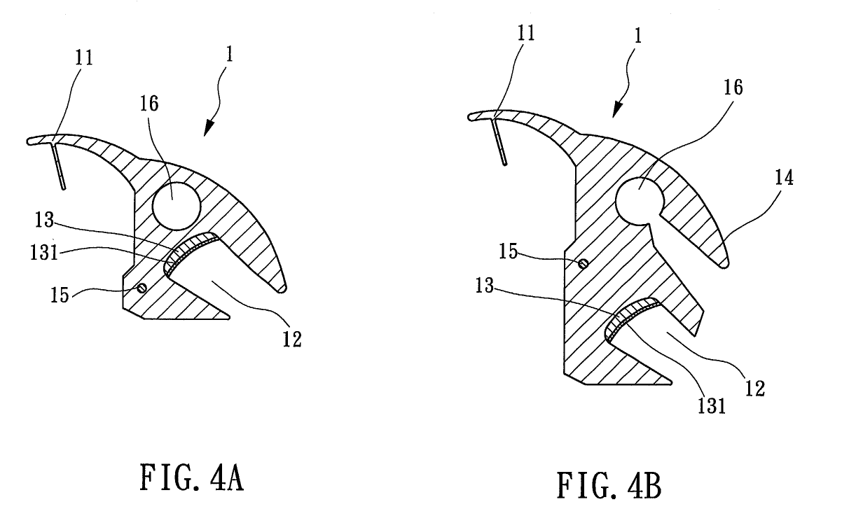

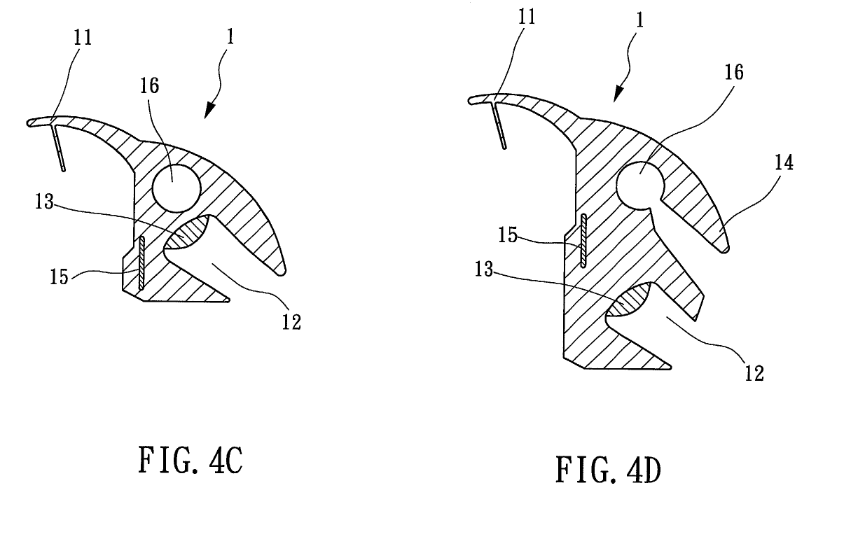

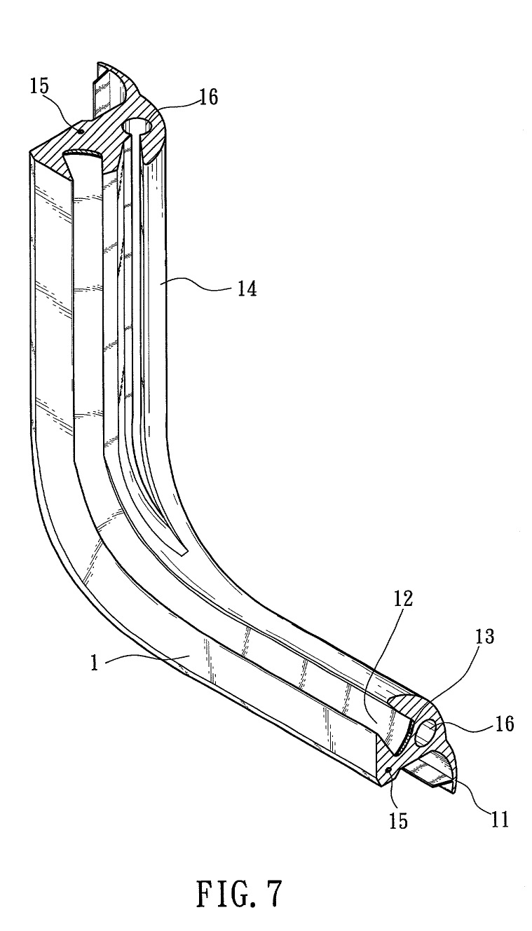

The present invention relates to the structure of a sealing strap of a windshield which having variable section and to the manufacturing device that produce said sealing strap. Please refer to FIG. 3, FIG. 4A, FIG. 4B and FIG. 7, all of them showing the outlook diagram of the sealing strap of the windshield of the present invention. Said sealing strap comprises a main body 1, on the end thereof with a windshield frame connecting part 11 which enable the present invention to be fixed on the windshield frame 21 of a car 2. On the front end of said main body 1, a containing slot 12 for windshield is placed, and detachable dual-side tape 131 or non-dry glue 13 (as shown in FIGS. 4A and 4B) is placed within said containing slot 12. Beside said containing slot 12 of said main body 1 on two sides of said windshield 22, water blocking blades 14 are placed. Comparing with prior art, the sealing strap of the present invention is made with modeling technology which solving the high cost problem in inventory management and having better sealing performance.

In said main body 1 of said structure of the present invention, there is a metal or non-metal core 15 placed along with the extension of said main body. Said core 15 can be wire-style (as shown in FIG. 4A or FIG. 4B) or slice-style (as shown in FIG. 4C and FIG. 4D). The placement of said core 15 will prevent the length of the present invention from change caused by the temperature of weather.

Additionally, drain slot 16 is placed in the inside bottom of said water blocking blades 14 to drain out huge volume of water generated suddenly by windshield wiper 23 wiping windshield 22 in heavy rains or a storm in which a driver driving a car. However, in prior art, without the drain slot in place, the rainwater is easy overflowing over the water blocking blade F and splashing on the side window E of car to block the car driver's vision toward the rear-view mirror.

More, for said main body 1 should fix the windshield 22 firmly, it has to be hard enough, however, the windshield frame connecting part 11 is made to joint the windshield frame 21, it could not be too hard but soft properly. Therefore, said main body 1 and said windshield frame connecting part 11 of the present invention are made of different material respectively and into a whole set to obtain better fixing performance.

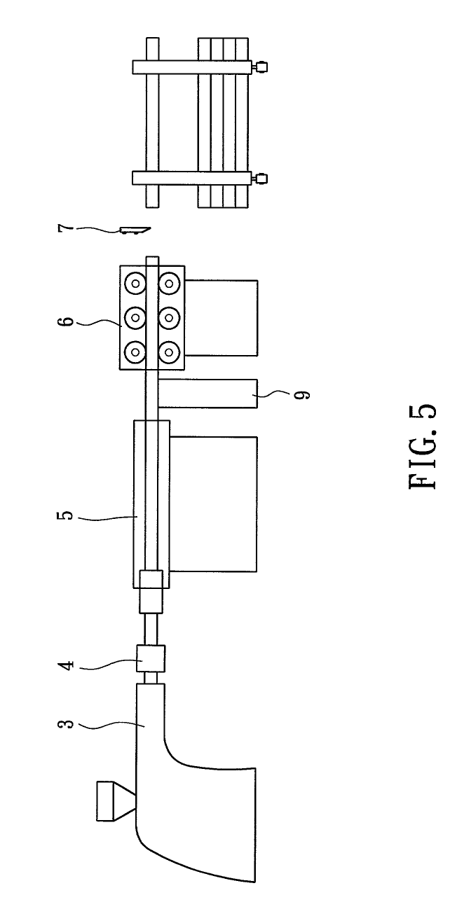

Further more, a manufacturing device (as shown in FIG. 5) is provided in the present invention to produce said sealing strap of windshield having water blocking blade that its section is variable, wherein, said device comprising extruder 3, mold 4, cooling tank 5, take up unit 6, cutter 7 and controller 8. Said extruder 3 will extrude raw material to said mold 4 to build up the shape of the product. After that, said product will be further sent into cooling tank 5 and then said take up unit 6 will apply proper guiding force on said product to control the size of product, finally, said cutter 7 will cut said product into proper length to complete the entire manufacturing process. Wherein, said mold 4 comprises a main mold body 41 and at least two sets of sliding blocks 42 and 43 that can move back and forth to produce the product in a modeling manner, and the movement of said sliding block 42 and 43 is controlled by said controller 8.

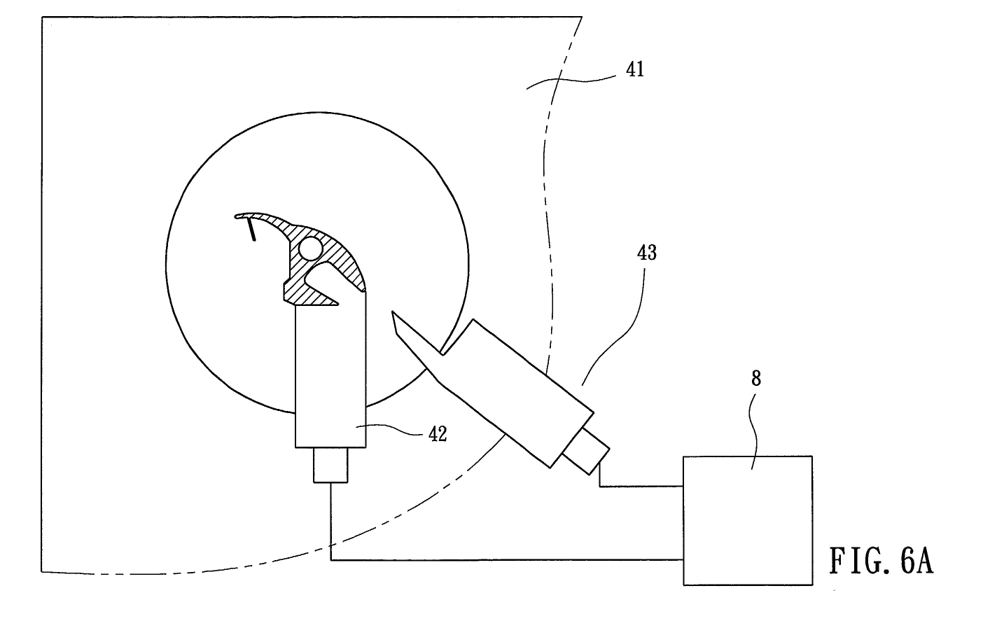

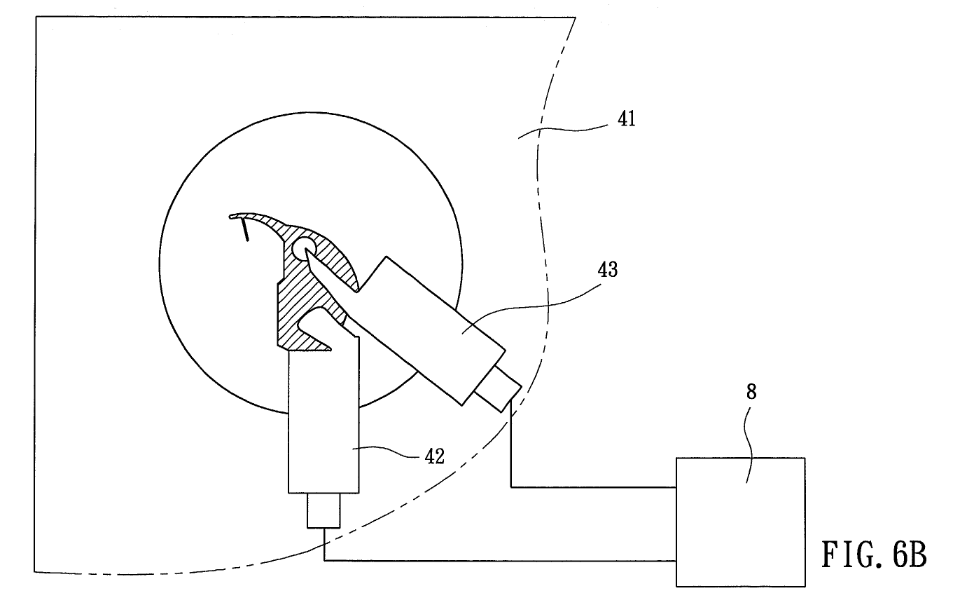

Please refer to FIGS. 6A and 6B, which are the top view of the operation of the sliding block 42 and 43 of the mold of the manufacturing device of the present invention. As shown, the sliding block 42 placed vertically is responsible to form the containing slot 12, while the sliding block 43 with a angle leaning against the main body 1 is responsible to form the blocking blade 14. In the production of the upper and lower sides of the sealing strap of the present invention, said sliding block 42 is protruding forward and said sliding block 43 is moving backward to produce a product, and the section thereof is as shown in FIG. 4A, wherein, a round hole 16 will be formed inside the main body 1. When the product of the sealing strap of the present invention reaching to the level of the right and left sides of the windshield 22, said controller 8 will properly drive the sliding block 42 to make it move backward and drive the sliding block 43 move forward, and therefore form a said blocking blade 14 (as shown in FIG. 4B) on said main body 1, and since the front end of said sliding block 43 is touching and a little bit over said round hole 16 of said main body 1, a drain slot is therefore formed.

Further, said mold 4 of the manufacturing device of the present invention could be formed of at least two different materials with different hardness extruded by the extruder 3. Thus, said main body 1 and said windshield frame connecting part 11 are made of different material respectively and into a whole set to obtain better fixing performance.

More, the cooling tank 5 and the cutter 7 of the manufacturing device of the present invention comprises a gluing apparatus 9. Said gluing apparatus 9 will place a detachable dual-side tape 131 or non-dry glue 13. User could just detach the detachable paper from the said tape 131 or press down said non-dry style glue 13, the windshield 22 will be fixed firmly in place.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A structure for a sealing strap of windshield with variable section, also a structure made by modeling technology and being used as a connecting device to connect a windshield frame and a windshield, comprising a main body, on the end thereof with a windshield frame connecting part which enabling the present invention to be fixed on said windshield frame, on the front end of said main body, a containing slot for windshield being placed, and detachable dual-side tape or non-dry glue being placed within said containing slot, beside said containing slot of said main body on two sides of said windshield, water blocking blades being placed, and in the inside bottom thereof, there is drain slot being placed.

2. A structure for a sealing strap of windshield with variable section of claim 1, wherein, a metal or non-metal core is placed inside said main body along the extension of said main body.

3. A structure for a sealing strap of windshield with variable section of claim 1, wherein, said core is wire-style.

4. A structure for a sealing strap of windshield with variable section of claim 1, wherein, said core is slice-style.

5. A structure for a sealing strap of windshield with variable section of claim 1, wherein, said main body and said windshield frame connecting part are made of two different materials with different hardness respectively and by modeling technology.

6. A manufacturing device for a sealing strap of windshield with variable section, comprising
at least one extruder to extrude raw material to a mold to build up the shape of the product;
a mold comprising a main mold body and at least two sets of sliding blocks that can move back and forth to produce the product in a modeling manner, and the movement of said sliding block is controlled by a controller;
a cooling tank to cool down the heat generated during the production;
a take up unit applying proper force on the output product to control the size of the product;
a cutter to cut the final product into proper length.

7. A manufacturing device for a sealing strap of windshield with variable section of claim 6, wherein, said mold could allow at least two extruder to provide at least two different materials with different hardness.

8. A manufacturing device for a sealing strap of windshield with variable section of claim 6, wherein, a gluing apparatus is placed between said cooling tank and said cutter.

9. A manufacturing device for a sealing strap of windshield with variable section of claim 6, wherein, said gluing apparatus will place a detachable dual-side tape on the surface of the containing slot of a windshield.

10. A manufacturing device for a sealing strap of windshield with variable section of claim 6, wherein, said gluing apparatus will place non-dry glue on the surface of the containing slot of a windshield.
